(19) United States
(12) Patent Application Publication
(10) Pub. No.: US 2020/0179200 A1
(43) Pub. Date: Jun. 11, 2020

(54) APPARATUS FOR A PROTECTIVE PAD FOR BEDS WITH RAILS

(71) Applicant: Fidelia Marthurin, Orlando, FL (US)

(72) Inventor: Fidelia Marthurin, Orlando, FL (US)

(21) Appl. No.: 16/215,024

(22) Filed: Dec. 10, 2018

(51) Int. Cl. A61G 7/05; A47C 21/08

(52) U.S. Cl. CPC A61G 7/0522; A47C 21/08

(57) ABSTRACT

A protective bumper pad for placing over a bed railed presented. The protective bumper pad includes an outer frame, a body pad and an inner pad. The outer frame is rigid or semi-rigid so that when the apparatus is completed it is secure and strong so that a patient will not easily break it. The body pad and inner pad are a soft, flexible but sturdy material that can protect a patient when they contact it without causing any injury to the patient. The elastic material allows for a tight fit with the bed rails and connecting ports allow a more secure installation.

### FIELD OF THE INVENTION

This invention relates to a protective pad for bed side rails generally and more particularly to such a protective pad which is adjustable in its fit and can be easily installed.

### BACKGROUND

While many retirees remain healthy, a certain percent unfortunately become infirmed or encounter physical ailments which will cause them to become bedridden. With the high number of elderly people who are or will be spending various periods of time in hospitals, long term care facilities, nursing homes, retirement homes, and home care, additional special hospital/geriatric beds are or will soon be needed. Those beds, which are currently used in hospitals by patients of all ages, usually have bed rails for helping to prevent patients from falling or getting out of bed.

Sometimes, the hands of patients who are delirious or who have diminished mental capacity are tied with padded wrist bands to bed rails to prevent them from leaving the bed or pulling out their intravenous transfusion lines (IVs). For those patients who are confined to a bed in a sterile room for most of the day, small comforts are much appreciated.

At other times, patients are subject to mental health issues. One of which is to have seizures. These seizures can cause the patient to move in various and sometimes obtuse directions. When these seizures occur in a hospital bed, the patients sometime hit their head on the bed side rails or may even physically fall from the bed and sustain an injury.

Bed rails usually comprise metal bars. They are cold and hostile looking, particularly when viewed up close from a prone position. Providing a protective bumper pad for the bed rails should also reduce minor injuries which result from bumping or scaping the hands, arms or legs against the bed rails and possibly pulling out an IV or other tubes attached to the patient. This is particularly important for the delirious patient who is tied to and may be thrashing against the bed and rails.

Bed rails can be short or long in length. Most hospital beds have two short rails on opposite Sides of the bed. When a person is lying in the bed, the rails are approximately at chest level. The set of rails at the lower end of the bed are to help discourage the patient from swinging his legs over the edge of the bed to get up. This helps to prevent falls.

Some beds have two short rails on opposite sides of the bed which telescope into longer rails of between about 75 and 80 inches in length. These rails can be used in the short position or be pulled out into a longer position once the patient is in the bed. The present bumper pad can also fit a telescoping bed rail. The protective bumper pad of the present invention has elastic aspects and can fit short bed rails or it can be stretched to fit longer bed rails.

### BRIEF DESCRIPTION OF THE DRAWINGS

FIG. 1 is a traditional hospital bed with bed side rails.

FIG. 2 are two exemplary protective bumper pads.

FIG. 3 an exemplary view of an exemplary protective bumper pad fitting over a bed side rail.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

With reference to the drawings wherein like numerals represent like parts throughout the figures.

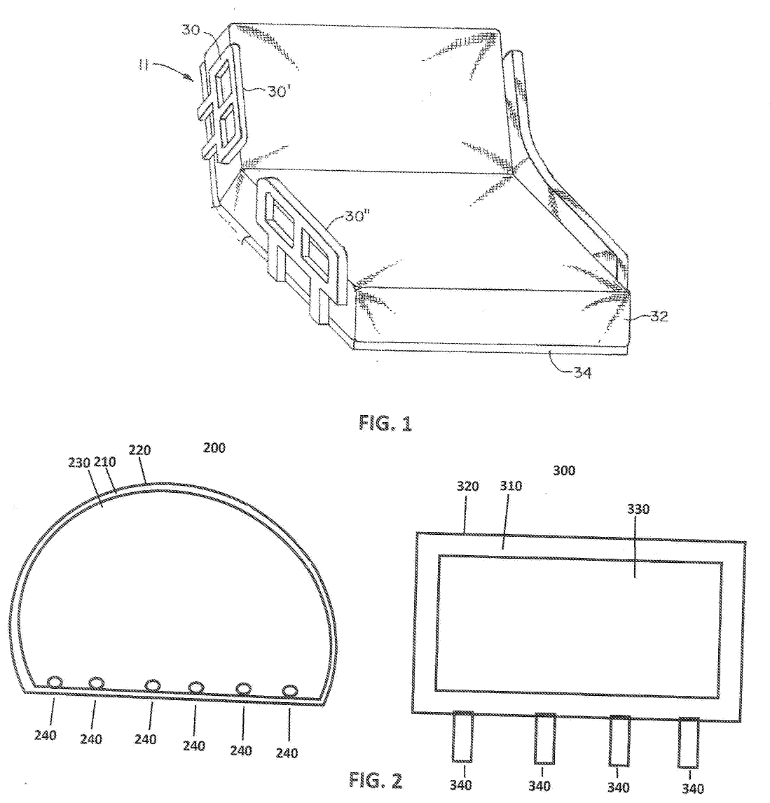

FIG. 1 presents a traditional hospital bed with side rails. The hospital bed 11 is of a type having a mattress 32, a mattress support 34, bed support means (not shown) and at least one bed rail 30 on each side. The bed rail 30 typically consists of a plurality of elongate, intersecting tubular members that are adapted to move up and down relative to the bed. Each bed rail 30 may be composed of a plurality of bed rail segments 30′, 30″.

The hospital bed has means (not shown) for adjusting the mattress 32 over a range of segmental elevational configurations. The mattress 32 is typically relatively stiff and does not conform exactly to the configuration assumed by the mattress support 34 resulting in relative movement between the mattress 32 and the bed rail 30. Additionally, movement of the mattress support 34 changes the position of the bed rail segments 30′, 30″ relative to each other.

Now moving to FIG. 2, two exemplary protective bumper pads 200, 300 are presented. The protective bumper pads 200, 300 are shown in two shapes, a half-moon protective bumper pad 200 and a rectangular protective bumper pad 300. Although, the exemplary protective bumper pads 200, 300 are shown in these shapes, any number of shapes may be contemplated, such as square, circular, hexagonal, etc. The shape of the protective bumper pad 200, 300 depends on the aesthetic properties and connectivity to the bed rails one is attaching the protective bumper pad 200,300.

The protective bumper pad 200 has an outer frame 210 and a pad body 220 that covers the entire protective bumper pad 200. The outer frame 210 is made of a rigid or a semi-rigid material such that when the protective bumper pad 200 is placed upon the bed rails 30, the protective bumper pad 200 is solid and secure. The rigid or semi-rigid material may be of any type that would allow the protective bumper pad 200 to be rigid and secure for the patient when installed. For example, the material may be polyvinyl chloride piping (PVC), copper piping, galvanized steel piping, chlorinated polyvinyl chloride piping (CPVC), cross-linked polyethylene piping (PEX), etc.

The pad body 220 of the protective bumper pad 200 also has an inner pad 230. The inner pad 230 is made of a material which is soft and cushioned. The inner pad 230 provides a solid barrier but also one in which if the patient falls or has a seizure does softens the collision and prevents injury. The exemplary inner pad 230 is made of a leather like fabric. The material may be any material which is soft yet does not easily split. The material may also be latex free, as hospitals are normally latex free because of allergies to latex that is becoming more common. The pad body 220 is preferably removable and washable.

The pad body 220 has one or more connecting ports 240. These connecting ports are used to secure the protective bumper pad 200 to the bed rails 30. The exemplary connecting ports 240 are shown as grommets but one can contemplate using any type of connecting ports 240 to secure the protective bumper pad 30 to the bed rails 30.

The protective bumper pad 300 has an outer frame 310 and a pad body 320 that covers the entire protective bumper pad 300. The outer frame 310 is made of a rigid or a semi-rigid material such that when the protective bumper pad 300 is placed upon the bed rails 30, the protective bumper pad 300 is solid and secure. The rigid or semi-rigid material may be of any type that would allow the protective bumper pad 300 to be rigid and secure for the patient when installed. For example, the material may be polyvinyl chloride piping (PVC), copper piping, galvanized steel piping, chlorinated polyvinyl chloride piping (CPVC), cross-linked polyethylene piping (PEX), etc.

The pad body 320 of the protective bumper pad 300 also has an inner pad 330. The inner pad 330 is made of a material which is soft and cushioned. The inner pad 330 provides a solid barrier but also one in which if the patient falls or has a seizure does softens the collision and prevents injury. The exemplary inner pad 330 is made of a leather like fabric. The material may be any material which is soft yet does not easily split. The material may also be latex free, as hospitals are normally latex free because of allergies to latex that is becoming more common. The pad body 320 is preferably removable and washable.

The pad body 320 has one or more connecting ports 340. These connecting ports are used to secure the protective bumper pad 300 to the bed rails 30. The exemplary connecting ports 340 are shown as Velcro straps but one can contemplate using any type of connecting ports 340 to secure the protective bumper pad 300 to the bed rails 30.

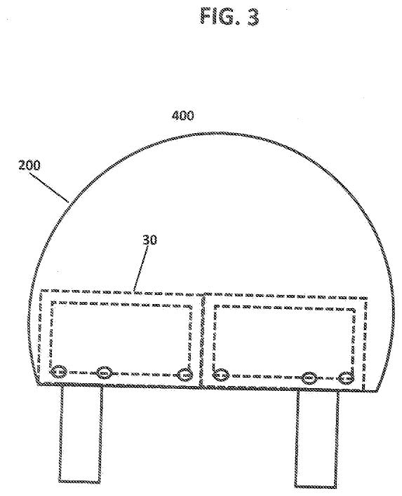

Moving now to FIG. 3, the completed product 400 shows an installed protective bumper pad 200 is secured to the bed rails 30. The protective bumper pad is stretch to cover the outside of the bed rails 30. The connecting ports 240, are shown as grommets, are connected to the bed rails 30 to secure the protective bumper pad 200 in place.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

I claim:

1. A protective bumper pad for placing over a bed rail, the bumper pad comprising:
a pad body, wherein the pad body contains an outer frame and an inner pad;
the outer frame of the pad body being rigid; the inner pad of the pad body being coupled to the outer frame of the pad body, wherein the inner pad of the pad body being a non-rigid material; and
the pad body having connecting ports, wherein the connecting ports are coupled to the bed rail and wherein the pad body being at least the length of the bed rail and the pad body being of greater height than the height of the bed rail.

2. The protective bumper pad of claim 1, wherein the non-rigid material of the inner pad of the pad body being a sponge-like material.

3. The protective bumper pad of claim 1, wherein the non-rigid material of the inner pad of the pad body being a leather.

4. The protective bumper pad of claim 1, wherein the non-rigid material of the inner pad of the pad body being removable.

5. The protective bumper pad of claim 1, wherein the outer frame of the pad body being polyvinyl chloride (PVC).

6. The protective bumper of claim 1, wherein the pad body has a flat side and a round side, wherein the flat side of the pad body corresponds to the bed rail and the round side of the pad body extending past the height of the bed rail.

7. The protective bumper pad of claim 1, wherein the non-rigid material of the inner pad of the pad body is latex free.

8. The protect bumper pad of claim 1, wherein the non-rigid material of the inner pad of the pad body is elastotic.

9. The protective bumper pad of claim 1, wherein the protective bumper pad is removable.

10. The protect bumper pad of claim 1, wherein the connecting ports of the pad body are snaps, wherein when the pad body envelops the bed rail and the connecting ports snap together to secure the pad body to the bed rail.

11. The protective bumper pad of claim 1, wherein the connecting ports of the body pad are Velcro, wherein when the pad body envelops the bed rail and the Velcro clings together to secure the pad body to the bed rail.
